(19) United States
(12) Patent Application Publication
(10) Pub. No.: US 2025/0350694 A1
(43) Pub. Date: Nov. 13, 2025

(54) IMAGE READING APPARATUS

(71) Applicant: SEIKO EPSON CORPORATION, TOKYO (JP)

(72) Inventors: Ryoichi SHUTO, Kitakyushu-shi (JP); Yoichiro NISHIMURA, Kitakyushu-shi (JP); Hiroki NAKASHIMA, Fukuoka-shi (JP); Shinsuke KOGI, MATSUMOTO-SHI (JP); Tokujiro OKUNO, Kitakyushu-shi (JP); Noriyuki KOYANAGI, Kitakyushu-shi (JP)

(21) Appl. No.: 19/278,857

(22) Filed: Jul. 24, 2025

Related U.S. Application Data
(63) Continuation of application No. 18/169,898, filed on Feb. 16, 2023.

(30) Foreign Application Priority Data
Feb. 17, 2022 (JP) 2022-022707

(51) Int. Cl. H04N 1/00

(52) U.S. Cl. CPC H04N 1/00602; H04N 1/0057; H04N 1/00615; H04N 1/00631; H04N 1/00633

(57) ABSTRACT

Provided is an image reading apparatus in which at least part of a feeding roller that feeds out a document placed on a document support unit to a first transport roller is present within a region of the first transport roller in an apparatus depth direction and a position at which the feeding roller and a document are brought into contact with each other is present within the region of the first transport roller in the apparatus depth direction.

This application is a continuation application of U.S. patent application Ser. No. 18/169,898 filed on Feb. 16, 2023, which claims priority from JP Application Serial Number 2022-022707, filed on Feb. 17, 2022. Each of the above-referenced applications is hereby incorporated herein by reference in its entirety.

### BACKGROUND

### 1. Technical Field

The present disclosure relates to an image reading apparatus that reads an image on a document.

### 2. Related Art

As an image reading apparatus exemplified by a scanner, there is a sheet feed type that reads an image on a document while transporting the document. Further, the image reading apparatus of this type includes a document transport path in which a document that is set in an inclined posture is transported and a document transport path in which a document that has high rigidity and hardly warps is transported in a linear manner (see JP-A-2012-216930).

The document transport path in which the document that has high rigidity and hardly warps is transported is required to be formed linearly. In many cases, a region passing through a reading unit in the document transport path is formed to extend along a horizontal direction.

Thus, when the document transport path in which the document that is set in an inclined posture is transported is to be formed, a depth dimension of the apparatus is disadvantageously increased.

### SUMMARY

In order to solve the above-mentioned problem, an image reading apparatus according to the present disclosure includes a reading unit configured to read an image on a document, a straight transport path being a document transport path passing through the reading unit and extending in an apparatus depth direction, a document support unit being positioned upper rearward with respect to the reading unit in the apparatus depth direction and being configured to support a document in an inclined posture, a feeding path configured to guide a document to a region facing the reading unit, the document being fed out from the document support unit, a first transport roller being a roller positioned rearward with respect to the reading unit in the apparatus depth direction and above the straight transport path, and being configured to apply a feeding force to a document fed in the feeding path and a document transported in the straight transport path, a feeding roller being a roller positioned upward with respect to the reading unit in the apparatus depth direction, and being configured to feed out a document placed on the document support unit from the document support unit to the first transport roller, and a separation unit being arranged to face the feeding roller and being configured to separate documents from each other, wherein at least part of the feeding roller is present within a region of the first transport roller in the apparatus depth direction, and a position at which the feeding roller and a document are brought into contact with each other is present within the region of the first transport roller in the apparatus depth direction.

The image reading apparatus according to the present disclosure further includes a reading unit configured to read an image on a document, a reading transport path being a document transport path facing the reading unit, and a unit including the reading unit and the reading transport path, wherein the unit is provided rotatably about a rotation center line along a width direction being a direction intersecting with an apparatus depth direction and a vertical direction, and is configured to switch, by rotating, between a first state in which the reading transport path is in an inclined posture and a second state in which the reading transport path is along the apparatus depth direction.

### BRIEF DESCRIPTION OF THE DRAWINGS

FIG. 1 is a schematic side cross-sectional view of a scanner according to a first exemplary embodiment, illustrating a state in which a U-turn transport path is used.

FIG. 2 is a schematic side cross-sectional view of the scanner according to the first exemplary embodiment, illustrating a state in which a straight turn transport path is used.

FIG. 3 is a schematic side cross-sectional view of a scanner according to a second exemplary embodiment, illustrating a state in which a U-turn transport path is used.

FIG. 4 is a schematic side cross-sectional view of the scanner according to the second exemplary embodiment, illustrating a state in which a straight turn transport path is used.

FIG. 5 is a schematic side cross-sectional view of a scanner according to a third exemplary embodiment, illustrating a state in which a U-turn transport path is used.

FIG. 6 is a schematic side cross-sectional view of the scanner according to the third exemplary embodiment, illustrating a state in which a straight turn transport path is used.

FIG. 7 is a view of a modification example of the scanner according to the third exemplary embodiment, as viewed from an apparatus front side.

FIG. 8 is a view of a modification example of the scanner according to the third exemplary embodiment, as viewed from above.

FIG. 9 is a view of main parts of a modification example of the scanner according to the third exemplary embodiment, as viewed from a side.

### DESCRIPTION OF EXEMPLARY EMBODIMENTS

The present disclosure is schematically described below. An image reading apparatus according to a first aspect includes a reading unit configured to read an image on a document, a straight transport path being a document transport path passing through the reading unit and extending in an apparatus depth direction, a document support unit being positioned upper rearward with respect to the reading unit in the apparatus depth direction and being configured to support a document in an inclined posture, a feeding path configured to guide a document to a region facing the reading unit, the document being fed out from the document support unit, a first transport roller being a roller positioned rearward with respect to the reading unit in the apparatus depth direction and above the straight transport path, and being configured to apply a feeding force to a document fed in the feeding path and a document transported in the straight transport path, a feeding roller being a roller positioned upward with respect to the reading unit in the apparatus depth direction, and being configured to feed out a document placed on the document support unit from the document support unit to the first transport roller, and a separation unit being arranged to face the feeding roller and being configured to separate documents from each other, wherein at least part of the feeding roller is present within a region of the first transport roller in the apparatus depth direction, and a position at which the feeding roller and a document are brought into contact with each other is present within the region of the first transport roller in the apparatus depth direction.

According to the present aspect, at least part of the feeding roller is present within the region of the first transport roller in the apparatus depth direction, and the position at which the feeding roller and a document are brought into contact with each other is present within the region of the first transport roller in the apparatus depth direction. Thus, the document support unit is positioned near the front as compared to the related-art configuration, and hence the depth dimension of the apparatus can be suppressed.

According to the first aspect, in a second aspect, the feeding roller has a rotation axis center that is present frontward of a rotation axis center of the first transport roller in the apparatus depth direction. According to the present aspect, the rotation axis center of the feeding roller is present frontward of the rotation axis center of the first transport roller in the apparatus depth direction. Thus, the document support unit can be arranged further near the front as compared to the related-art configuration, and hence the depth dimension of the apparatus can further be suppressed.

According to the first aspect or the second aspect, in a third aspect, a document fed out from the document support unit passes through a position facing the reading unit, and then enters a discharge path curved upward. According to the present aspect, the document fed out from the document support unit passes through the position facing the reading unit, and then enters the discharge path curved upward. Thus, a space for discharging the document fed out from the document support unit (a space in the apparatus depth direction) can be suppressed.

In a fourth aspect, the image reading apparatus according to the third aspect further includes a second transport roller being a roller positioned frontward with respect to the reading unit in the apparatus depth direction and above the straight transport path, and being configured to apply a feeding force to a document fed in the discharge path and a document transported in the straight transport path, and a discharge roller pair configured to discharge a document from the discharge path, wherein at least part of at least one roller forming the discharge roller pair is present in a region of the second transport roller in the apparatus depth direction. According to the present aspect, at least part of at least one roller forming the discharge roller pair is present in the region of the second transport roller in the apparatus depth direction. Thus, the position of the discharge roller pair in the apparatus depth direction is close to the position of the second transport roller, and hence the depth dimension of the apparatus can be suppressed.

In a fifth aspect, the image reading apparatus according to the fourth aspect further includes a first driven roller configured to nip a document with the first transport roller, the document being fed in the feeding path, a second driven roller configured to nip a document with the second transport roller, the document being transported in the discharge path, a third driven roller being a roller configured to nip a document with the first transport roller and being a roller different from the first driven roller, the document being transported in the straight transport path, and a fourth driven roller being a roller configured to nip a document with the second transport roller and being a roller different from the second driven roller, the document being transported in the straight transport path.

According to the present aspect, the first transport roller and the second transport roller can be utilized for both transport of a document using the feeding path and the discharge path and transport of a document using the straight transport path. Thus, increase in size and cost of the apparatus can be suppressed.

According to the fifth aspect, in a sixth aspect, the reading unit includes a first reading unit positioned above the straight transport path and a second reading unit positioned below the straight transport path, the first reading unit and the second reading unit are provided to be displaceable in an up-and-down direction, when the second reading unit is displaced to an upper limit position, the second reading unit closes the straight transport path while enabling transportation of a document using the feeding path and the discharge path, and when the first reading unit is displaced to a lower limit position, the first reading unit closes a path from the feeding path to the discharge path while enabling transportation of a document using the straight transport path. According to the present aspect, a configuration dedicated for switching the document transport paths is not required, and hence increase in size and cost of the apparatus can be suppressed.

An image reading apparatus according to a seventh aspect includes a reading unit configured to read an image on a document, a reading transport path being a document transport path facing the reading unit, a unit including the reading unit and the reading transport path, a document support unit being positioned upper rearward with respect to a rotation center of the unit as viewed in a width direction, and being configured to support a document in an inclined posture, the width direction being a direction intersecting with an apparatus depth direction and a vertical direction, wherein the unit is provided rotatably about a rotation center line along the width direction, and is configured to switch, by rotating, between a first state in which the reading transport path is in an inclined posture and a second state in which the reading transport path is along the apparatus depth direction, when the unit is in the first state, a document transport path in which a document fed out from the document support unit is discharged via the reading transport path is formed, and when the unit is in the second state, a straight transport path is formed, the straight transport path being a transport path including the reading transport path and extending in the apparatus depth direction.

According to the present aspect, the unit including the reading unit and the reading transport path is provided rotatably, and is configured to switch, by rotating, between the first state in which the reading transport path is in an inclined posture and the second state in which the reading transport path is along the apparatus depth direction. Thus, the document support unit is positioned near the front as compared to the related-art configuration, and hence the depth dimension of the apparatus can be suppressed.

### First Exemplary Embodiment

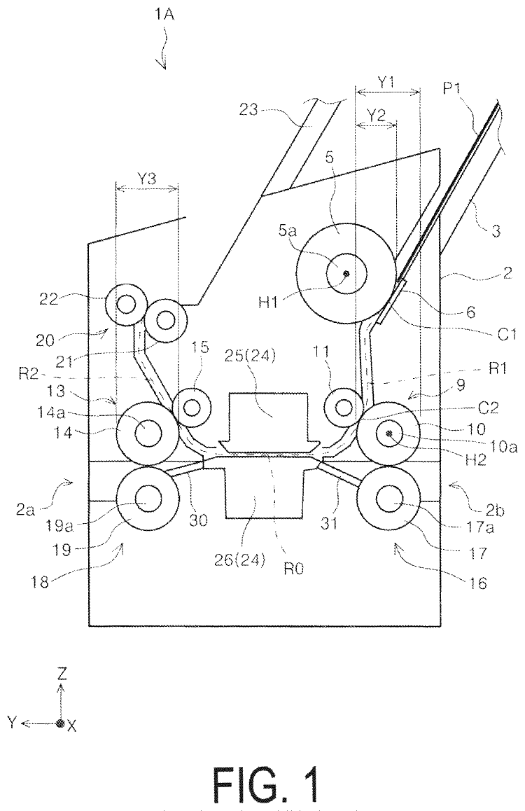

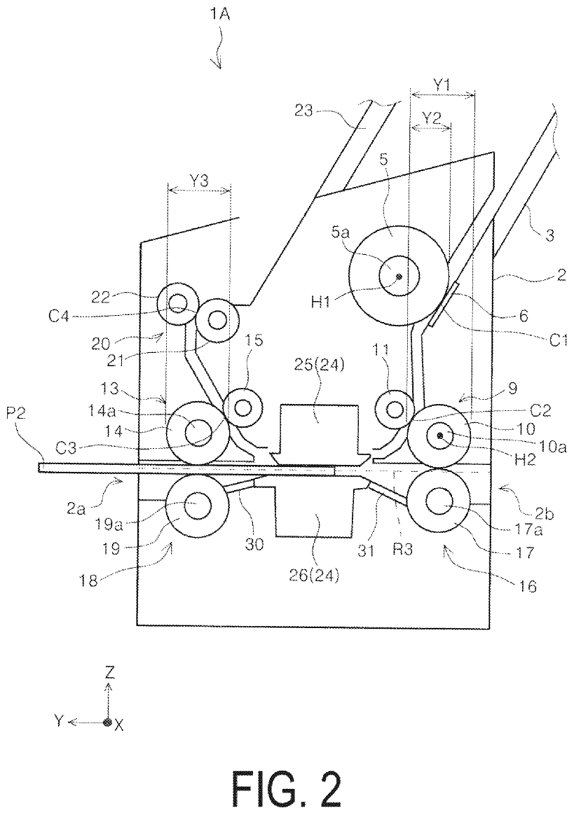

The present disclosure is specifically described below. A scanner 1A of a sheet feed type is described below as an example of the image reading apparatus, with reference to FIG. 1 and FIG. 2. Note that an X-Y-Z coordinate system illustrated in each of the drawings is an orthogonal coordinate system, where an X-axis direction and a Y-axis direction correspond to a horizontal direction and a Z-axis direction corresponds to a vertical direction. The X-axis direction corresponds to an apparatus width direction and a document width direction. The Y-axis direction corresponds to the apparatus depth direction, a +Y direction corresponds to a direction from an apparatus back surface to an apparatus front surface, and a −Y direction corresponds to a direction from the apparatus front surface to the apparatus back surface. In other words, the apparatus front surface is a side surface in the +Y direction. Note that, in the following description, a direction to which a document is transported is referred to as “downstream”, and a direction opposite thereto is referred to as “upstream” in some cases.

As illustrated in FIG. 1, the scanner 1A includes a feeding tray 3 that supports a document P1 before feeding in an inclined posture, at a rear-upper part of an apparatus main body 2. The feeding tray 3 is an example of the document support unit. The document P1 supported on the feeding tray 3 is fed out from a feeding roller 5 driven by a motor, which is not illustrated. The document P1 is, for example, plain paper that easily warps. The reference symbol 5a indicates a rotation axis of the feeding roller 5. At a position facing the feeding roller 5, there is provided a separation pad 6 being an example of a separation unit that separates the document P1. Note that a separation roller may be used in place of the separation pad 6.

A feeding path R1 in which the document P1 fed out from the feeding roller 5 is transported is provided downstream of the feeding roller 5. In the present exemplary embodiment, it is assumed that the feeding path R1 is from a contact position C1 of the feeding roller 5 and the separation pad 6 to an entry position between a first reading unit 25 and a second reading unit 26, which are described later.

In the middle of the feeding path R1, the first driving roller 10 being an example of the first transport roller is provided, and a first driven roller 11 that nips the document P1 with the first driving roller 10 is provided. The first driving roller 10 and the first driven roller 11 form a first transport roller pair 9. The first driving roller 10 is driven by a motor, which is not illustrated. The reference symbol 10a indicates a rotation axis of the first driving roller 10. The first driven roller 11 is capable of advancing toward and retracting from the first driving roller 10, and is pressed toward the first driving roller 10 by a pressing member (for example, a spring), which is not illustrated.

A reading means 24 is provided downstream of the first transport roller pair 9. The reading means 24 includes the first reading unit 25 positioned at an upper part thereof and the second reading unit 26 positioned at a lower part thereof. In the present exemplary embodiment, the first reading unit 25 and the second reading unit 26 is a contact image sensor module. A document transport path R0 is formed between the first reading unit 25 and the second reading unit 26. While the document P1 is transported in the document transport path R0, a first surface thereof and a second surface opposite thereto are read. The first reading unit 25 and the second reading unit 26 are provided to extend in the X-axis direction, and are configured so as to have lengths in the X-axis direction that cover the entire area in the document width direction. Note that the maximum fixed size of the document width that can be read by the reading means 24 is a short side of the A4 size defined by the international standard ISO 216, for example.

The document P1 exits from the reading transport path R0, and then enters a discharge path R2 curved upward. A second driving roller 14 being an example of the second transport roller is provided downstream of the reading means 24 in the discharge path R2, and a second driven roller 15 that nips the document P1 with the second driving roller 14 is provided. The second driving roller 14 and the second driven roller 15 form a second transport roller pair 13. The second driving roller 14 is driven by a motor, which is not illustrated. The reference symbol 14a indicates a rotation axis of the second driving roller 14. The second driven roller 15 is capable of advancing toward and retracting from the second driving roller 14, and is pressed toward the second driving roller 14 by a pressing member (for example, a spring), which is not illustrated.

A discharge roller pair 20 is provided downstream of the second transport roller pair 13. The discharge roller pair 20 is configured to include a discharge driving roller 21 driven by a motor, which is not illustrated, and a discharge driven roller 22 that nips the document P1 with the discharge driving roller 21 and is driven to rotate. The discharge driven roller 22 is capable of advancing toward and retracting from the discharge driving roller 21, and is pressed toward the discharge driving roller 21 by a pressing member (for example, a spring), which is not illustrated. The document P1 is discharged by the discharge roller pair 20 toward a discharge tray 23. The discharge tray 23 supports the discharged document P1 in an inclined posture. In this manner, the document P1 is transported in the document transport path that includes the feeding path R1, the reading transport path R0, and the discharge path R2 and is formed into a U-like shape as a whole.

The scanner 1A is capable of provide a straight transport path R3 illustrated in FIG. 2, in addition to the document transport path formed into a U-like shape as described above. Description is made below on switching between the U-like document transport path and the straight transport path R3. The first reading unit 25 and the second reading unit 26 are configured to be displaced in an up-and-down direction in an integrated manner by a cam, which is not illustrated. When the document transport path formed into a U-like shape, which is illustrated in FIG. 1, is used, the first reading unit 25 is positioned in the upper direction in a displaceable region in the up-and-down direction, and is fixed in such a state. The second reading unit 26 is provided to be displaceable in the up-and-down direction, and is pressed toward the first reading unit 25 by a spring, which is not illustrated.

Next, when the straight transport path R3 illustrated in FIG. 2 is used, the first reading unit 25 and the second reading unit 26 are integrally displaced downward from the state in FIG. 1. With this, the first reading unit 25 provides partition between the feeding path R1 and the discharge path R2. When a document P2 enters a gap between the first reading unit 25 and the second reading unit 26 in this state, the second reading unit 26 is displaced downward in accordance with a thickness of the document P2. In other words, the gap between the first reading unit 25 and the second reading unit 26 is adjustable through displacement of the second reading unit 26. The document P2 is a document that hardly warps and has a thickness, such as a booklet and a card. Note that the reference symbols 30 and 31 indicate guide members provided integrally with the second reading unit 26. The guide members 30 and 31 also moves with the second reading unit 26 in the up-and-down direction.

The cam, which is not illustrated, for integrally moving the first reading unit 25 and the second reading unit 26 in the up-and-down direction receives a driving force from an actuator such as a motor and a solenoid, and thus rotates. Rotation of the above-mentioned cam is controlled by a controller, which is not illustrated. For example, when a user designates a document type via an operation panel (not illustrated), the control unit controls rotation of the above-mentioned cam in response to the designation. Thus, the state in FIG. 1 or FIG. 2 is obtained. Alternatively, there may be adopted a configuration in which the above-mentioned cam rotates when a user operates an operation lever, for example.

A third driven roller 17 is provided rearward with respect to the reading means 24 in the straight transport path R3. The third driven roller 17 is capable of advancing toward and retracting from the first driving roller 10, and is pressed toward the first driving roller 10 by a pressing member (for example, a spring), which is not illustrated. The reference symbol 17a indicates a rotation axis of the third driven roller 17. The first driving roller 10 and the third driven roller 17 form a third transport roller pair 16.

Further, a fourth driven roller 19 is provided frontward with respect to the reading means 24 in the straight transport path R3. The fourth driven roller 19 is capable of advancing toward and retracting from the second driving roller 14, and is pressed toward the second driving roller 14 by a pressing member (for example, a spring), which is not illustrated. The reference symbol 19a indicates a rotation axis of the fourth driven roller 19. The second driving roller 14 and the fourth driven roller 19 form a fourth transport roller pair 18. The third driven roller 17 and the fourth driven roller 19 move in the up-and-down direction in accordance with a thickness of the document P2.

Note that the third driven roller 17 and the fourth driven roller 19 may be driving rollers driven by a motor, instead of the driven rollers.

In the present exemplary embodiment, the outer diameters of the third driven roller 17 and the fourth driven roller 19 are larger than the outer diameters of the first driven roller 11 and the second driven roller 15. Further, in the present exemplary embodiment, the outer diameters of the third driven roller 17 and the fourth driven roller 19 are equal to the outer diameters of the first driving roller 10 and the second driving roller 14.

The document P2 that hardly warps and has a thickness, such as a booklet and a card can be inserted in the straight transport path R3 through a front opening 2a in the apparatus front surface or a rear opening 2b in the apparatus back surface. When the document P2 is inserted through the front opening 2a, the first driving roller 10 and the second driving roller 14 rotate in a counterclockwise direction in FIG. 2, and thus transport the document P2 toward the apparatus back surface. At this timing, the reading means 24 performs reading. When the document P2 is read, part of the document P2 projects rearward from the rear opening 2b in some cases. Note that, in this case, the document P2 is discharged through the front opening 2a through rotation of the first driving roller 10 and the second driving roller 14 in a clockwise direction in FIG. 2. However, in addition to this, the document P2 may be discharged directly through the rear opening 2b. Further, the document P2 may be inserted through the rear opening 2b and discharged through the front opening 2a. Alternatively, the document P2 may be inserted through the rear opening 2b and discharged through the rear opening 2b. Note that the straight transport path R3 is not necessarily required to be parallel to the horizontal direction, and may form a certain angle with respect to the horizontal direction.

As described above, the scanner 1 includes the reading means 24 that reads an image on a document, the straight transport path R3 that is a document transport path passing through the reading means 24 and extends in the apparatus depth direction, the feeding tray 3 that is positioned upper rearward with respect to the reading means 24 in the Y-axis direction, that is, the apparatus depth direction, and supports a document in an inclined posture, and the feeding path R1 that guides a document fed out from the feeding tray 3 to the region facing the reading means 24. Further, the scanner 1 includes the first driving roller 10 that is a roller positioned rearward of the reading means 24 in the apparatus depth direction and above the straight transport path R3 and applies a feeding force to the document P1 fed in the feeding path R1 and the document P2 fed in the straight transport path R3.

Further, the scanner 1A includes the feeding roller 5 and the separation pad 6. The feeding roller 5 is a roller positioned above the reading means 24 in the apparatus depth direction, and feeds out the document P1 placed on the feeding tray 3, from the feeding tray 3 to the first driving roller 10. The separation pad 6 is arranged to face the feeding roller 5, and separates documents from each other. Further, at least part of the feeding roller 5 is within a region denoted with the reference symbol Y1 in the apparatus depth direction, that is, a region of the first driving roller 10, and the contact position C1 at which the feeding roller 5 and the document P1 are brought into contact with each other is within the region Y1. With this, the feeding tray 3 is positioned near the front as compared to the related-art configuration, and hence the depth dimension of the apparatus can be suppressed. Note that a configuration in which the entire feeding roller 5 is present within the region Y1 may be adopted.

Further, a rotation axis center H1 of the feeding roller 5 is present frontward of a rotation axis center H2 of the first driving roller 10 in the apparatus depth direction. With this, the feeding tray 3 can be arranged further near the front as compared to the related-art configuration, and hence the depth dimension of the apparatus can further be suppressed.

Note that the rotation axis center H1 of the feeding roller 5 is present between the reading means 24 and the rotation axis center H2 of the first driving roller 10 in the apparatus depth direction. Further, a region denoted with the reference symbol Y2 is a region between a position rearward of the feeding roller 5 and a position frontward of the first driving roller 10 in the apparatus depth direction. Further, a route section from the contact position C1 between the feeding roller 5 and the separation pad 6 to a contact position C2 between the first driving roller 10 and the first driven roller 11 in the feeding path R2 falls within the region Y2.

Further, the document P1 fed out from the feeding tray 3 passes through a position facing the reading means 24, and then enters the discharge path R2 curved upward. With this, the space for discharging the document P1 fed out from the feeding tray 3 (a space in the apparatus depth direction) can be suppressed.

Further, the scanner 1A includes the second driving roller 14 and the discharge roller pair 20. The second driving roller 14 is a roller that is positioned frontward of the reading means 24 in the apparatus depth direction and above the straight transport path R3, and applies a feeding force to the document P1 transported in the discharge path R2 and the document P2 transported in the straight transport path R3. The discharge roller pair 20 discharged the document P1 from the discharge path R2. Further, at least part of at least one roller forming the discharge roller pair 20 is present within a region Y3 of the second driving roller 14 in the apparatus depth direction. With this, the position of the discharge roller pair 20 in the apparatus depth direction is close to the position of the second driving roller 14, and hence the depth dimension of the apparatus can be suppressed. Note that, in the present exemplary embodiment, part of the discharge driving roller 21 and part of the discharge driven roller 22 are present within the region Y3, but part of any one of the discharge driving roller 21 and the discharge driven roller 22 may be present within the region Y3. Further, the entire discharge driving roller 21 and the entire discharge driven roller 22 may be present within the region Y3, or any one of the entire discharge driving roller 21 and the entire discharge driven roller 22 may be present within the region Y3.

Further, the scanner 1A includes the first driven roller 11 that nips, with the first driving roller 10, the document P1 fed in the feeding path R1, and the second driven roller 15 that nips, with the second driving roller 14, the document P1 transported in the discharge path R2. Further, the scanner 1A includes the third driven roller 17 and the fourth driven roller 19. The third driven roller 17 is a roller that nips, with the first driving roller 10, the document P2 transported in the straight transport path R3, and is a roller different from the first driven roller 11. The fourth driven roller 19 is a roller that nips, with the second driving roller 14, the document P2 transported in the straight transport path R3, and is a roller different from the second driven roller 15. With this, the first driving roller 10 and the second driving roller 14 can be utilized for both transport of the document P1 using the feeding path R1 and the discharge path R2 and transport of the document P2 using the straight transport path R3. Thus, increase in size and cost of the apparatus can be suppressed.

Further, the reading means 24 includes the first reading unit 25 positioned above the straight transport path R3 and the second reading unit 26 positioned below the straight transport path R3, and the first reading unit 25 and the second reading unit 26 are provided to be displaceable in the up-and-down direction. Further, when the second reading unit 26 is displaced to the upper limit position (the state in FIG. 1), the second reading unit 26 closes the straight path R3 while enabling transportation of the document P1 using the feeding path R1 and the discharge path R2. Further, when the first reading unit 25 is displaced to the lower limit position (the state in FIG. 2), the first reading unit 25 closes the path from the feeding path R1 to the discharge path R2 while enabling transportation of the document P2 using the straight transport path R3. With this configuration as described above, a configuration dedicated for switching the document transport paths is not required, and hence increase in size and cost of the apparatus can be suppressed.

### Second Exemplary Embodiment

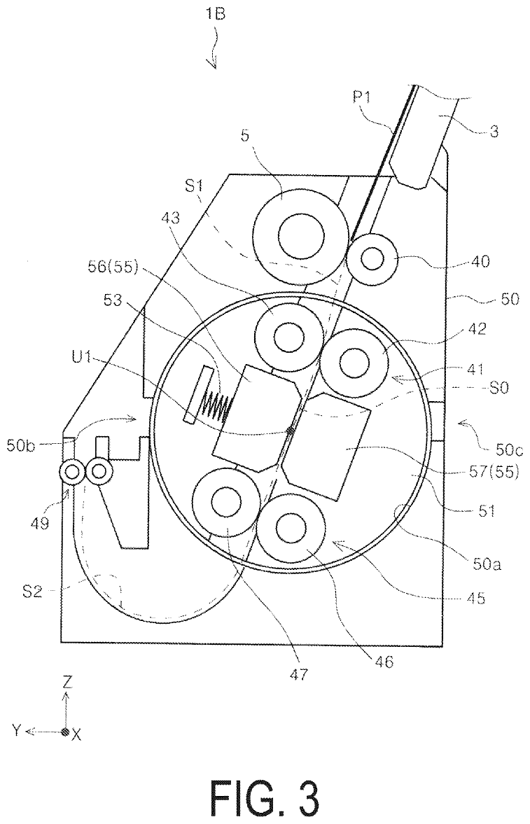

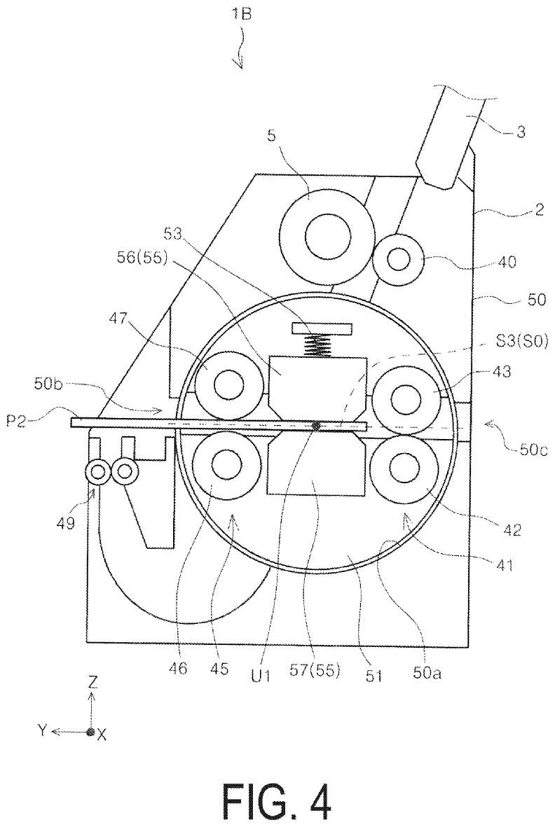

Next, with reference to FIG. 3 and FIG. 4, a scanner 1B of a sheet feed type according to a second exemplary embodiment is described. Note that the configurations similar to the configurations described above are denoted with the same reference symbols, and description therefor is omitted below. The scanner 1B includes a separation roller 40 in place of the separation pad 6 described above.

Note that, as a matter of course, a separation pad may be used in place of the separation roller 40.

An apparatus main body 50 has a space 50a having a perfect circular shape as viewed in the width direction. A space 50a extends in the width direction. The apparatus main body 50 includes a unit 51 inside the space 50a. The unit 51 has a perfect circular shape as viewed in the width direction and a shape extending in the width direction, that is, has a cylindrical shape. The unit 51 is provided with a first transport roller pair 41, a reading means 55, and a second transport roller pair 45.

The first transport roller pair 41 includes a first driving roller 42 driven by a motor, which is not illustrated, and a first driven roller 43 that is driven to rotate. The first driven roller 43 is capable of advancing toward and retracting from the first driving roller 42, and is pressed toward the first driving roller 42 by a pressing member, which is not illustrated. The second transport roller pair 45 includes a second driving roller 46 driven by a motor, which is not illustrated, and a second driven roller 47 that is driven to rotate. The second driven roller 47 is capable of advancing toward and retracting from the second driving roller 46, and is pressed toward the second driving roller 46 by a pressing member, which is not illustrated.

A reading transport path SO is formed between a first reading unit 56 and a second reading unit 57 that form the reading means 55. It is assumed that the reading transport path SO is a document transport path between the first transport roller pair 41 and the second transport roller pair 45. The first reading unit 56 is capable of advancing toward and retracting from the second reading unit 57, and is pressed toward the second reading unit 57 by a pressing spring 53 being an example of a pressing member.

The unit 51 is provided rotatably in a clockwise direction and a counterclockwise direction in FIG. 3 and FIG. 4. Rotation of the unit 51 may be performed by a driving force of a motor or the like under control of a control unit, which is not illustrated, or may be performed manually by a user. The reference symbol U1 indicates the unit 51. The unit 51 rotates about a rotation center line parallel to the X-axis direction. The unit 51 rotates to perform switching between a first state in which, as illustrated in FIG. 3, the reading transport path SO is in an inclined posture and a second state in which, as illustrated in FIG. 4, the reading transport path SO is along the apparatus depth direction.

In the first state in which the reading transport path SO is in an inclined posture, as illustrated in FIG. 3, upstream of the reading transport path SO is coupled to a feeding path S1, and downstream of the reading transport path S0 is coupled to a discharge path S2. With this, the U-like document transport path for transporting the document P1 is formed. The document P1 after reading passes through the discharge path S2, and is discharged by a discharge roller pair 49 provided to the discharge path S2.

In the second state in which the reading transport path SO is along the apparatus depth direction, as illustrated in FIG. 4, a straight transport path S3 including the reading transport path SO is formed. The document P2 that hardly warps and has a thickness, such as a booklet and a card can be inserted in the straight transport path S3 through a front opening 50b in the apparatus front surface or a rear opening 50c in the apparatus back surface. When the document P2 is inserted through the front opening 50b, the first driving roller 42 and the second driving roller 46 rotate in the clockwise direction in FIG. 4, and thus transport the document P2 toward the apparatus back surface. AT this timing, the reading means 55 performs reading. When the document P2 is read, part of the document P2 projects rearward from the rear opening 50c in some cases. Note that, in this case, the document P2 is discharged through the front opening 50b through rotation of the first driving roller 42 and the second driving roller 46 in the counterclockwise direction in FIG. 4. However, in addition to this, the document P2 may be discharged directly through the rear opening 50c. Further, the document P2 may be inserted through the rear opening 50c and discharged through the front opening 50b. Alternatively, the document P2 may be inserted through the rear opening 50c and discharged through the rear opening 50c.

Note that the straight transport path S3 is not necessarily required to be parallel to the horizontal direction, and may form a certain angle with respect to the horizontal direction.

As described above, the scanner 1B includes the reading means 55 that reads an image on a document, the reading transport path SO being a document transport path facing the reading means 55, the unit 51 including the reading means 55 and the reading transport path SO, and the feeding tray 3 that is positioned upper rearward with respect to the rotation center U1 of the unit 51 as viewed in the width direction being a direction intersecting with the apparatus depth direction and the vertical direction and supports the document P1 in an inclined posture. The unit 51 is provided to rotate about the rotation center line along the width direction, and is capable of performing switching through rotation between the first state in which the reading transport path SO is in an inclined posture and the second state in which the reading transport path So is along the apparatus depth direction. Further, when the unit 51 is in the first state, the document transport path in which the document P1 fed out from the feeding tray 3 is discharged via the reading transport path SO is formed. When the unit 51 is in the second state, the straight transport path S3 that is a transport path including the reading transport path SO and extends in the apparatus depth direction is formed. With this configuration as described above, the feeding tray 3 is positioned near the front as compared to the related-art configuration, and hence the depth dimension of the apparatus can be suppressed.

### Third Exemplary Embodiment

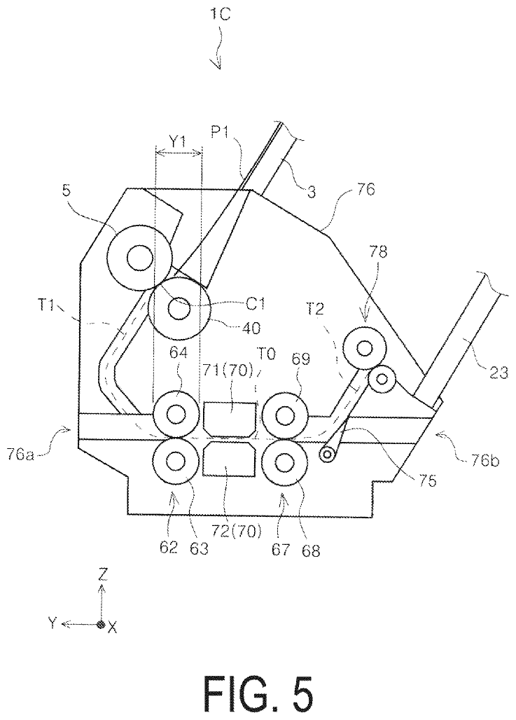

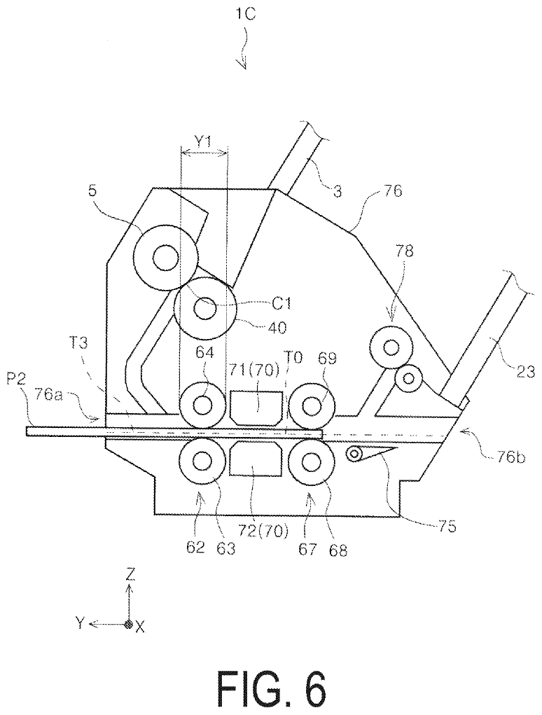

Next, with reference to FIG. 5 and FIG. 6, a scanner 1C of a sheet feed type according to a third exemplary embodiment is described. Note that the configurations similar to the configurations described above are denoted with the same reference symbols, and description therefor is omitted below. The scanner 1C includes the feeding tray 3 on a front side of an apparatus main body 76, and also includes the discharge tray 23 of a rear side thereof. The document P1 placed on the feeding tray 3 passes through a feeding path T1, arrives at a first transport roller pair 62, and enters a reading transport path TO. The first transport roller pair 62 includes a first driving roller 63 driven by a motor, which is not illustrated, and a first driven roller 64 that is driven to rotate. The first driven roller 64 is capable of advancing toward and retracting from the first driving roller 63, and is pressed toward the first driving roller 63 by a pressing member, which is not illustrated.

A reading means 70 is provided rearward of the first transport roller pair 62, and a second transport roller pair 67 is provided further rearward thereof. The reading transport path TO is formed between a first reading unit 71 and a second reading unit 72 that form the reading means 70. It is assumed that the reading transport path TO is a document transport path between the first transport roller pair 62 and the second transport roller pair 67. The first reading unit 71 is capable of advancing toward and retracting from the second reading unit 72, and is pressed toward the second reading unit 72 by a pressing member, which is not illustrated, such as a spring.

The second transport roller pair 67 includes a second driving roller 68 driven by a motor, which is not illustrated, and a second driven roller 69 that is driven to rotate. The second driven roller 69 is capable of advancing toward and retracting from the second driving roller 68, and is pressed toward the second driving roller 68 by a pressing member, which is not illustrated.

A discharge path T2 is formed rearward of the second transport roller pair 67. A flap 75 performs switching between the discharge path T2 and a straight transport path T3, which is described later. The flap 75 is provided rotatably while receiving a driving force of a driving source, which is not illustrate. Through rotation, switching is performed between the state of forming the discharge path T2, which is illustrated in FIG. 5, and the state of forming the straight transport path T3, which is illustrated in FIG. 6. The document P1 fed to the discharge path T2 is discharged by a discharge roller pair 78 toward the discharge tray 23. As described above, the document P1 fed from the feeding tray 3 is transported in the U-like transport path.

Next, in FIG. 6, the document P2 that hardly warps and has a thickness, such as a booklet and a card can be inserted in the straight transport path T3 through a front opening 76a in the apparatus front surface and a rear opening 76b in the apparatus back surface. When the document P2 is inserted through the front opening 76a, the first driving roller 63 and the second driving roller 68 rotate in a clockwise direction in FIG. 6, and thus transport the document P2 toward the apparatus back surface. At this timing, the reading means 70 performs reading. When the document P2 is read, part of the document P2 projects rearward from the rear opening 76b in some cases. Note that, in this case, the document P2 is discharged through the front opening 76a through rotation of the first driving roller 63 and the second driving roller 68 in a counterclockwise direction in FIG. 6. However, in addition to this, the document P2 may be discharged directly through the rear opening 76b. Further, the document P2 may be inserted through the rear opening 76b and discharged through the front opening 76a. Alternatively, the document P2 may be inserted through the rear opening 76b and discharged through the rear opening 76b.

Note that the straight transport path T3 is not necessarily required to be parallel to the horizontal direction, and may form a certain angle with respect to the horizontal direction.

Further, the scanner 1C includes the feeding roller 5 and the separation roller 40. The feeding roller 5 is a roller positioned above the reading means 70 in the apparatus depth direction, and feeds out the document P1 placed on the feeding tray 3, from the feeding tray 3 to the first driving roller 63. The separation roller 40 is arranged to face the feeding roller 5, and separates documents from each other. Further, at least part of the feeding roller 5 is within a region denoted with the reference symbol Y1 in the apparatus depth direction, that is, a region of the first driving roller 63, and the contact position C1 at which the feeding roller 5 and the document P1 are brought into contact with each other is within the region Y1. With this, the feeding tray 3 approaches the reading means 70 in the apparatus depth direction, and hence the depth dimension of the apparatus can be suppressed.

Note that the configuration in which the entire feeding roller 5 is present within the region Y1 may be adopted.

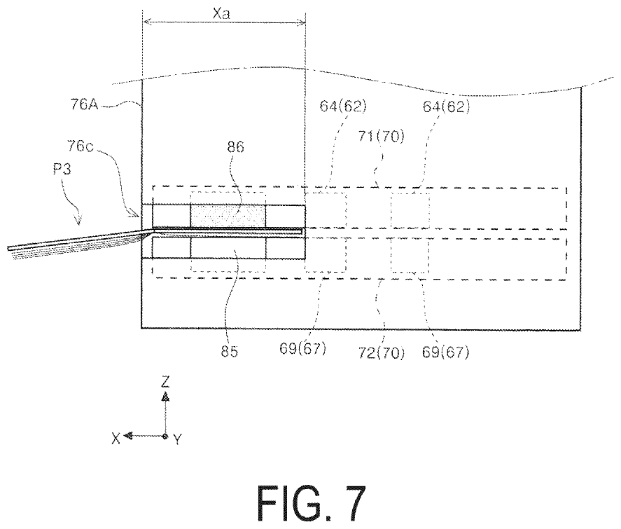

Further, in the scanner 1C, instead of providing the front opening 76a and the rear opening 76b, that is, instead of providing the straight transport path T3, a transport path for booklet reading may partially be provided to a side surface in the apparatus width direction (the X-axis direction). This matter is described below with reference to FIG. 7 to FIG. 9. For example, a passport is given as an example of a booklet. FIG. 7 is a view of the apparatus as seen from the front surface, and illustrates a lower side of an apparatus main body 76A. The left direction (+X direction) in FIG. 7 is an apparatus left side as viewed from a user, and the right direction (−X direction) in FIG. 7 is an apparatus right side as viewed from a user. A side opening 76c is formed in the left side surface of the apparatus main body 76A. A width Xa of the side opening 76c has such a size that enables reading of a page on one side in a state in which a booklet P3 is opened. Note that the side opening 76c may be formed in the right side surface of the apparatus main body 76A instead of the left side surface.

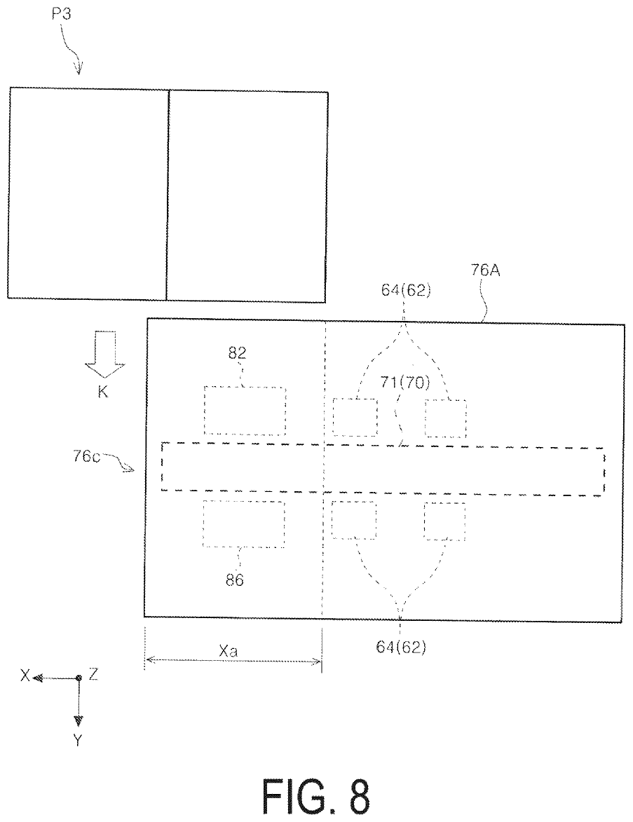

As illustrated in FIG. 8, the booklet P3 passes through the inside of the side opening 76c from the rear side to the front side of the apparatus main body 76A as indicated with the arrow K, and reading can be performed in the middle. In this case, a lower side of the booklet P3 corresponds to a reading surface, and thus is subjected to reading by the second reading unit 72.

Note that reading may be performed while moving the booklet P3 from the front side to the rear side of the apparatus main body 76A. Further, the first reading unit 71 may perform reading with the reading surface facing upward.

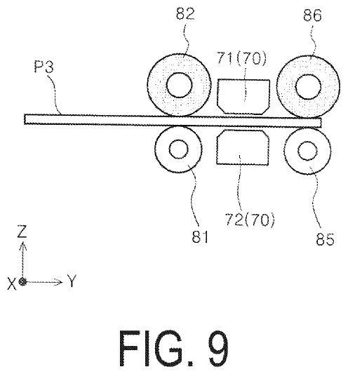

As illustrated in FIG. 9, a first driving roller 81, a first driven roller 82, a second driving roller 85, and a second driven roller 86 are provided in a region through which the booklet P3 passes. The first driving roller 81 and the second driving roller 85 are driven by a motor, which is not illustrated. the first driven roller 82 and the second driven roller 86 are capable of advancing toward and retracting from the facing driving rollers, and are pressed toward the facing driving rollers by a pressing member, which is not illustrated. Note that the document P1 (see FIG. 5) is nipped between the first driving roller 81 and the first driven roller 82, in addition to the first transport roller pair 62 and the second transport roller pair 67, and is further nipped between the second driving roller 85 and the second driven roller 86.

In the present exemplary embodiment, each of the driven rollers has an outer diameter larger than that of each of the driving rollers, and has a thickness twice as large as the maximum thickness of the booklet P3. Further, each of the driving rollers may be formed of, for example a rubber roller, and each of the driven rollers may be formed of a material having an elastic modulus lower than each of the driving rollers, for example, urethane.

Each of the driven rollers is formed of a soft material as described above. With this, even when the booklet P3 has a level difference, the level difference can be absorbed. According to the configuration described above, a user himself or herself can secure a space required on the front side or the rear side of the apparatus main body 76A at the time of reading the booklet P3, and thus improves usability.

The present disclosure is not intended to be limited to the exemplary embodiments described above, and many variations are possible within the scope of the disclosure as described in the appended claims. It goes without saying that such variations also fall within the scope of the disclosure.

What is claimed is:

1. An image reading apparatus, comprising:
at least one image sensor configured to read an image on a document;
a straight transport path that includes a document transport path passing through the at least one image sensor and extending in an apparatus depth direction;
a feeding tray that is positioned upper rearward with respect to the at least one image sensor in the apparatus depth direction, wherein the feeding tray is configured to support the document in an inclined posture;
a feeding path configured to guide the document to a region facing the at least one image sensor, wherein the document is fed out from the feeding tray;
a first transport roller positioned rearward with respect to the at least one image sensor in the apparatus depth direction and above the straight transport path, wherein the first transport roller is configured to apply a feeding force to the document fed in the feeding path and the document transported in the straight transport path; and
a feeding roller positioned upward with respect to the at least one image sensor in the apparatus depth direction, wherein
the at least one image sensor is positioned above the document transport path,
the feeding roller is configured to feed out the document placed on the feeding tray from the feeding tray to the first transport roller,
the feeding roller has a rotation axis center that is present frontward of a rotation axis center of the first transport roller in the apparatus depth direction when the feeding roller is brought into contact with the document, and
when viewed along an axis of the feeding roller, the feeding roller overlaps with the first transport roller in a vertical direction.

2. The image reading apparatus according to claim 1, wherein the document fed out from the feeding tray passes through a position facing the at least one image sensor, and subsequently enters a discharge path curved upward.

3. The image reading apparatus according to claim 2, further comprising:
a second transport roller positioned frontward with respect to the at least one image sensor in the apparatus depth direction and above the straight transport path,
wherein the second transport roller is configured to apply a feeding force to the document fed in the discharge path and the document transported in the straight transport path; and
a discharge roller pair configured to discharge the document from the discharge path,
when viewed along an axis of the second transport roller, the discharge roller pair overlaps with the second transport roller in the vertical direction.

4. The image reading apparatus according to claim 3, further comprising:
a first driven roller configured to nip the document fed in the feeding path, with the first transport roller;
a second driven roller configured to nip the document transported in the discharge path, with the second transport roller;
a third driven roller configured to nip the document transported in the straight transport path, with the first transport roller,
wherein the third driven roller is different from the first driven roller; and
a fourth driven roller configured to nip the document transported in the straight transport path, with the second transport roller,
wherein the fourth driven roller is different from the second driven roller.
